(19) United States
(12) Patent Application Publication
(10) Pub. No.: US 2020/0187457 A1
(43) Pub. Date: Jun. 18, 2020

(54) Dog Waste Collection Assembly

(71) Applicant: Lilieth Dunkley, Port St. Lucie, FL (US)

(72) Inventor: Lilieth Dunkley, Port St. Lucie, FL (US)

(21) Appl. No.: 16/220,190

(22) Filed: Dec. 14, 2018

(51) Int. Cl. A01K 23/00

(52) U.S. Cl. CPC A01K 23/005

(57) ABSTRACT

A dog waste collection assembly for capturing dog feces without requiring physical contact with the dog feces includes a handle that has a closed ring positioned thereon. The closed ring is positioned beneath a dog's anus when the dog is defecating. A plurality of bags is included and a selected one of the bags is positionable on the closed ring on the handle. In this way the selected bag can capture feces as the dog defecates.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to collection devices and more particularly pertains to a new collection device for collecting dog feces without requiring physical contact with the dog feces.

### BRIEF SUMMARY OF THE INVENTION

An embodiment of the disclosure meets the needs presented above by generally comprising a handle that has a closed ring positioned thereon. The closed ring is positioned beneath a dog's anus when the dog is defecating. A plurality of bags is included and a selected one of the bags is positionable on the closed ring on the handle. In this way the selected bag can capture feces as the dog defecates.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto. The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dog waste collection assembly according to an embodiment of the disclosure.

FIG. 2 is a perspective in-use view of an embodiment of the disclosure.

FIG. 3 is a perspective in-use view of an embodiment of the disclosure showing feces being scooped into a bag.

FIG. 4 is a perspective in-use view of an embodiment of the disclosure showing a bag being closed and being removed from a closed ring.

### DETAILED DESCRIPTION OF THE INVENTION

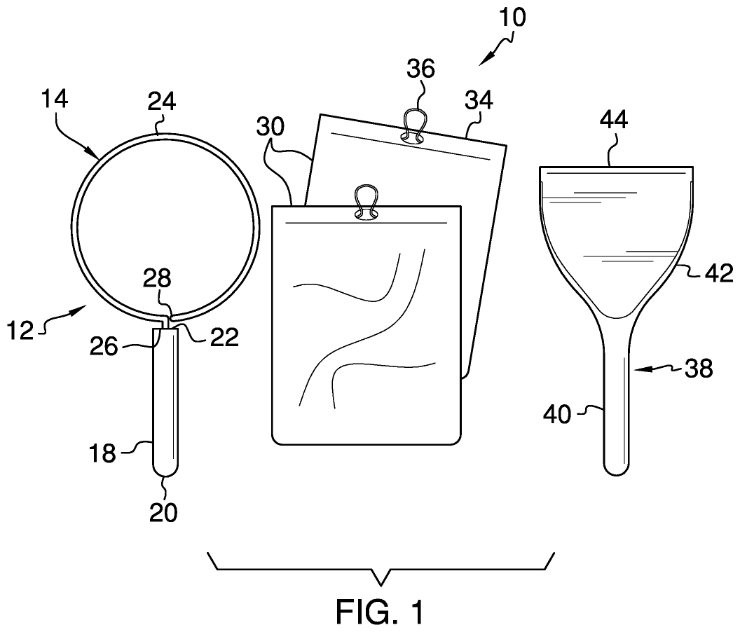

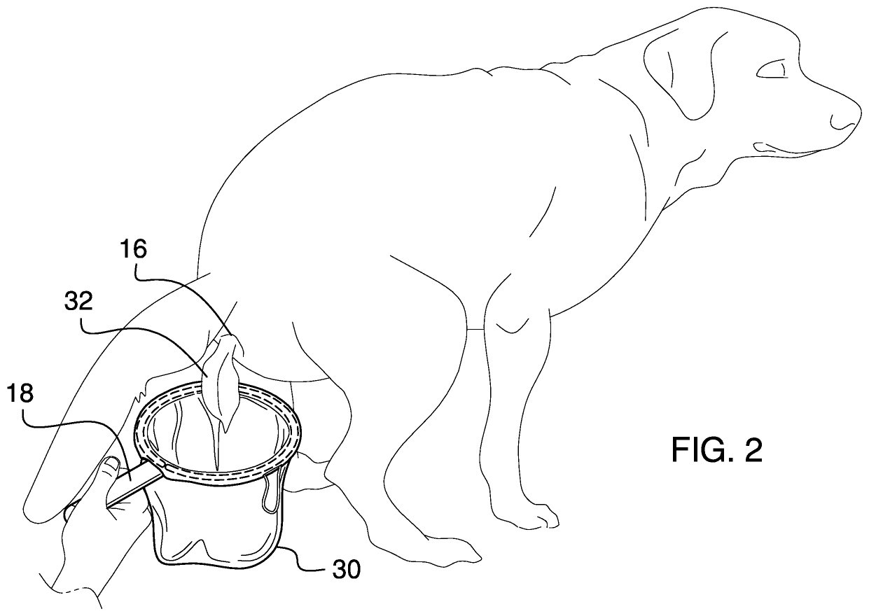

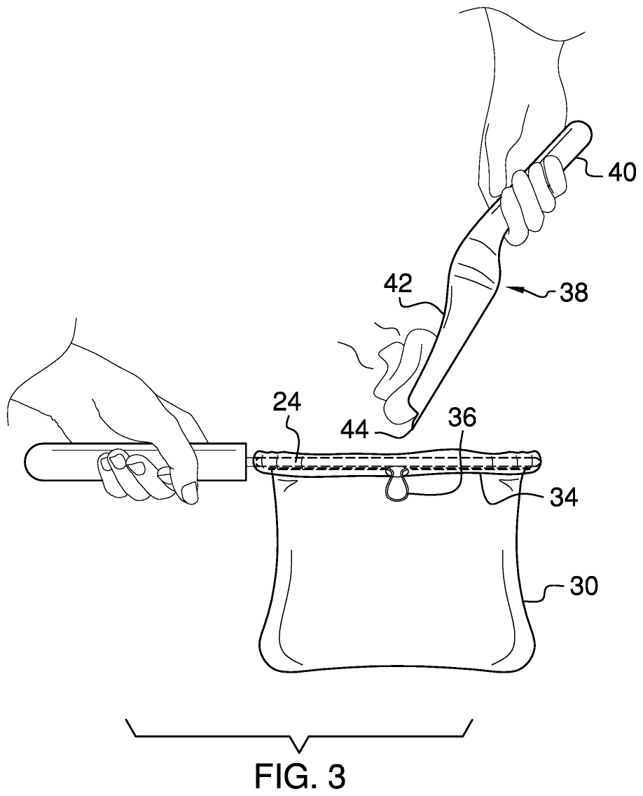

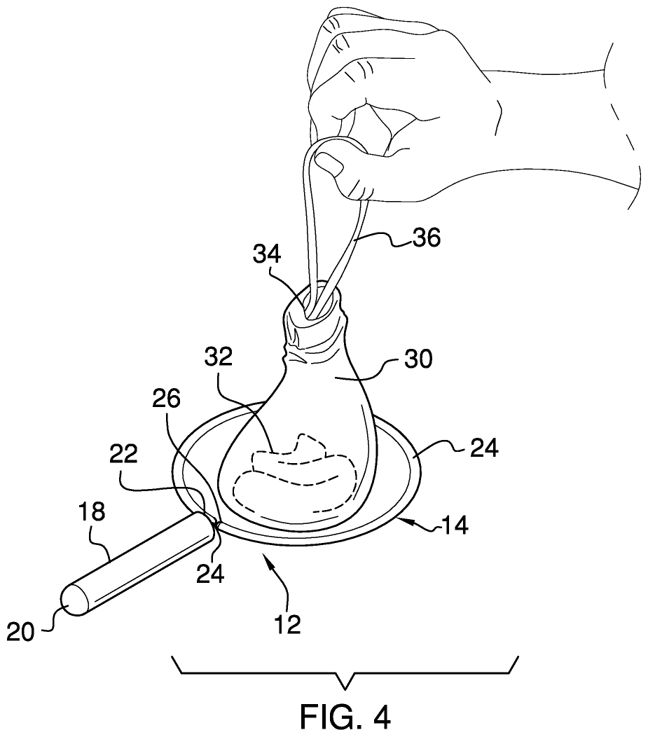

With reference now to the drawings, and in particular to FIGS. 1 through 4 thereof, a new collection device embodying the principles and concepts of an embodiment of the disclosure and generally designated by the reference numeral 10 will be described.

As best illustrated in FIGS. 1 through 4, the dog waste collection assembly 10 generally comprises a handle 12 that has a closed ring 14 positioned thereon. The closed ring 14 is positioned beneath a dog's anus 16 when the dog is defecating. The handle 12 comprises a grip 18 that has a first end 20 and a second end 22, and the grip 18 is elongated between the first 20 and second 22 ends. The handle 12 includes a wire 24 that has a primary end 26 and a secondary end 28. The wire 24 is bent into a circle having the primary end 26 being spaced from the secondary end 28 such that the wire 24 defines the closed ring 14. the primary end 26 is coupled to the second end 22 of the grip 18 having the closed ring 14 extending away from the second end 22.

A plurality of bags 30 is provided and a selected one of the bags 30 is positionable on the closed ring 14 on the handle 12. Thus, the selected bag 30 captures feces 32 when the closed ring 14 is positioned beneath the dog's anus 16 as the dog defecates. In this way the feces 32 can be captured without requiring a user to ever make contact with the feces 32. Each of the bags 30 has a top end 34 that is open and a drawstring 36 that is aligned with the top end 34. The top end 34 of the selected bag 30 is wrapped over the wire 24 having the selected bag 30 extending downwardly within the closed ring 14. The drawstring 36 is tightened for closing the selected bag 30 and to remove the selected bag 30 from the wire 24.

A scoop 38 is included and the scoop 38 is manipulated to scoop feces 32 from the ground. The scoop 38 is further manipulated to deposit the scooped feces 32 into the selected bag 30 when the selected bag 30 is positioned on the closed ring 14 on the handle 12. In this way any feces 32 that was not captured during defecation can be disposed of. The scoop 38 has a handle 40 and a scooping head 42, and the scooping head 42 has an open end 44 for scooping the feces 32 from the ground. The scoop 38 may be structured in the convention of a hand shovel or the like.

In use, a selected bag 30 is positioned in the closed ring 14 defined by the wire 24 and the top end 34 of the selected bag 30 is wrapped downwardly over the wire 24. Thus, the selected bag 30 is retained in an open position and the selected bag 30 can be positioned beneath the dog's anus 16 when the dog is defecating. In this way the feces 32 can be captured for disposal before the feces 32 falls to the ground. The drawstring 36 on the selected bag 30 is tightened for removing the selected bag 30 from the wire 24 and for closing the selected bag 30. In this way the feces 32 can be collected and bagged without requiring the user to make contact with the feces 32. The scoop 38 can be manipulated to scoop 38 feces 32 from the ground that was not captured in the selected bag 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A dog waste collection assembly being configured to collect dog feces for subsequent disposal, said assembly comprising:
a handle having a closed ring being positioned thereon wherein said closed ring is configured to be positioned beneath a dog's anus when the dog is defecating; and
a plurality of bags, a selected one of said bags being positionable on said closed ring on said handle wherein said selected bag is configured to capture feces as the dog defecates, each of said bags has a top end, said top end being open, each of said bags having a drawstring being aligned with said top end for closing said bag, said top end of said selected bag being wrapped over said wire having said bag extending downwardly within said closed ring, said drawstring closing said bag when said drawstring is pulled away from said top end wherein said drawstring facilitates removal of said bag from said closed ring when said drawstring is pulled to close said bag.

2. The assembly according to claim 1, further comprising handle comprises:
a grip having a first end and a second end, said grip being elongated between said first and second ends; and
a wire having a primary end and a secondary end, said wire being bent into a circle having said primary end being spaced from said secondary end such that said wire defines said closed ring, said primary end being coupled to said second end of said grip having said closed ring extending away from said second end.

3. (canceled)

4. The assembly according to claim 1, further comprising a scoop being manipulated to scoop feces from the ground, said scoop being further manipulated to deposit the scooped feces into said selected bag when said selected bag is positioned on said closed ring on said handle, said scoop having a handle and a scooping head, said scooping head having an open end for scooping the feces from the ground.

5. A dog waste collection assembly being configured to collect dog feces for subsequent disposal, said assembly comprising:
a handle having a closed ring being positioned thereon wherein said closed ring is configured to be positioned beneath a dog's anus when the dog is defecating, handle comprising:
a grip having a first end and a second end, said grip being elongated between said first and second ends; and
a wire having a primary end and a secondary end, said wire being bent into a circle having said primary end being spaced from said secondary end such that said wire defines said closed ring, said primary end being coupled to said second end of said grip having said closed ring extending away from said second end;
a plurality of bags, a selected one of said bags being positionable on said closed ring on said handle wherein said selected bag is configured to capture feces as the dog defecates, each of said bags having a top end, said top end being open, each of said bags having a drawstring being aligned with said top end for closing said bag, said top end of said selected bag being wrapped over said wire having said bag extending downwardly within said closed ring, said drawstring closing said bag when said drawstring is pulled away from said top end wherein said drawstring facilitates removal of said bag from said closed ring when said drawstring is pulled to close said bag; and
a scoop being manipulated to scoop feces from the ground, said scoop being further manipulated to deposit the scooped feces into said selected bag when said selected bag is positioned on said closed ring on said handle, said scoop having a handle and a scooping head, said scooping head having an open end for scooping the feces from the ground.
